(19) United States
(12) Patent Application Publication
(10) Pub. No.: US 2025/0292225 A1
(43) Pub. Date: Sep. 18, 2025

(54) READING DEVICE, METHOD, AND SYSTEM

(71) Applicant: Toshiba Tec Kabushiki Kaisha, Tokyo (JP)

(72) Inventor: Nobuo MUROFUSHI, Susono Shizuoka (JP)

(21) Appl. No.: 18/983,105

(22) Filed: Dec. 16, 2024

(30) Foreign Application Priority Data
Mar. 13, 2024 (JP) 2024-038975

(51) Int. Cl. G06Q 20/20; G06K 7/10

(52) U.S. Cl. CPC G06Q 20/208; G06K 7/10366

(57) ABSTRACT

A reading device for reading item information about an item to be registered by a POS terminal includes a main body from which a reading signal is output, a grip including a sensor at a bottom portion thereof, the bottom portion being attachable to a holding structure, and a controller configured to: based on a signal from the sensor, determine whether the reading device is in a first state in which the reading device is attached to the structure or in a second state in which the reading device is detached from the structure, determine an intensity of the reading signal to be output based on whether the reading device is in the first or second state, cause the reading signal to be output with the determined intensity and acquire item information, and transmit the item information to the POS terminal.

### CROSS-REFERENCE TO RELATED APPLICATION(S)

This application is based upon and claims the benefit of priority from Japanese Patent Application No. 2024-038975, filed Mar. 13, 2024, the entire contents of which are incorporated herein by reference.

### FIELD

Embodiments described herein relate generally to a reading device, a method, and a system.

### BACKGROUND

In recent years, there has been an increase in the use of a reading device such as an optical scanner for optically reading a symbol such as a barcode attached to an item to be sold in a store such as a clothing store, a supermarket, a convenience store, or a mass retailer. Further, in such a store, a wireless tag reading device has also been used for reading information from a wireless tag attached to an item using, for example, a radio frequency identification (RFID) technique.

There are two types of reading devices including a fixed type reading device that is fixed to a holding table and reads a symbol of a movable item, and a handheld type reading device that can be held by an operator to read a symbol of a large and/or heavy item. For example, in the case of a fixed type optical reading device, the output power of scanning light can be small because a symbol attached to an item to be read is brought to the scanning window, but in the case of a handheld type optical reading device, an item may be at a slightly distant position relative to the reading device, so the output power needs to be stronger.

On the other hand, in the case of a fixed type wireless tag reading device, since the wireless tags attached to a plurality of items placed in a basket need to be read collectively, the reading device needs to transmit wireless signals with high output power. On the other hand, in the case of a handheld type wireless tag reading device, the output power needs to be weaker so as not to erroneously read information from non-target items.

For this reason, in the related art, both fixed type and handheld type reading devices are provided in a store.

### SUMMARY OF THE INVENTION

Embodiments of the present disclosure provide a hybrid reading device operable as a fixed type reading device and a handheld type reading device.

In one embodiment, a reading device for reading item information about an item to be registered for purchase by a point-of-sale (POS) terminal, comprises: a main body from which a reading signal is output, a grip connected to the main body and including a sensor at a bottom portion of the grip, the bottom portion being attachable to a holding structure, and a controller configured to: based on a signal from the sensor, determine whether the reading device is in a first state in which the reading device is attached to the holding structure or in a second state in which the reading device is detached from the holding structure, determine an intensity of the reading signal to be output based on whether the reading device is in the first state or the second state, cause the reading signal to be output with the determined intensity and acquire item information from a response signal, and transmit the acquired item information to the POS terminal for registration.

### BRIEF DESCRIPTION OF THE DRAWINGS

FIG. 1 is a diagram illustrating a wireless tag reading device and a point-of-sale (POS) terminal according to an embodiment.

FIG. 2 is a schematic diagram illustrating a structure of the wireless tag reading device.

FIG. 3 is a schematic diagram illustrating a structure of the wireless tag reading device mounted on a holding table.

FIG. 4 is a block diagram illustrating a hardware configuration of the wireless tag reading device.

FIG. 5 is a data structure of a state storage table.

FIG. 6 depicts data stored in a memory.

FIG. 7 is a sequence diagram illustrating a process performed by a wireless tag, the wireless tag reading device, and the POS terminal.

FIG. 8 is a functional block diagram of the wireless tag reading device.

FIG. 9 is a flowchart illustrating a control process performed by the wireless tag reading device.

FIG. 10 is a flowchart illustrating a control process performed by the wireless tag reading device.

FIG. 11 is an explanatory diagram illustrating a structure of a wireless tag reading device according to a modification.

FIG. 12 is a block diagram illustrating a hardware configuration of a holding station.

FIG. 13 is a functional block diagram of the wireless tag reading device and the holding station.

FIG. 14 is a flowchart illustrating a control process performed by the holding station.

FIG. 15 is a flowchart illustrating a control process performed by the wireless tag reading device.

### DETAILED DESCRIPTION

Hereinafter, embodiments will be described in detail with reference to the drawings. Embodiments of the present disclosure are not limited to the embodiments described below.

In the following embodiments, a wireless tag reading device will be described as an example of a reading device.

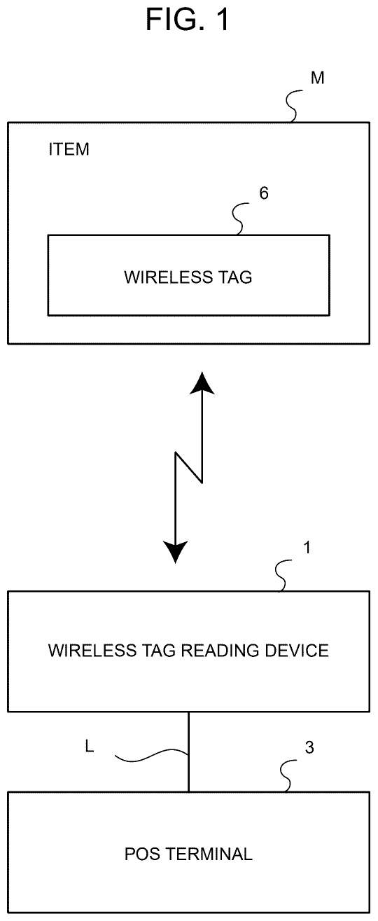

FIG. 1 is a diagram of a wireless tag reading device 1 and a POS terminal connected to each other according to an embodiment. FIG. 1 shows only one POS terminal 3, but two or more POS terminals 3 can be installed in a store such as a clothing store, a supermarket, a convenience store, and a mass retailer, and two or more wireless tag reading devices 1 are respectively connected to those POS terminals 3.

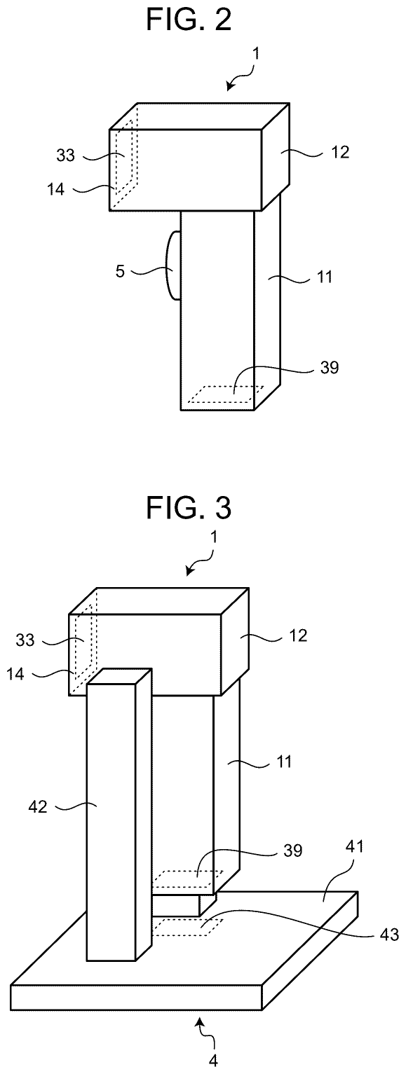

As illustrated in FIG. 1, the wireless tag reading device 1 is a device that performs wireless communication with a wireless tag 6 attached to an item M, and reads information of the item M by receiving tag information including an individual item code that uniquely specifies the item M stored in the wireless tag 6. Further, the wireless tag reading device 1 is connected to the POS terminal 3 installed in a checkout area of a store in a communicable manner through a connection line L. Details of the wireless tag reading device 1 will be described later with reference to FIGS. 2 and 3.

The POS terminal 3 performs an item registration process and a payment process for an item M on the basis of its item code received from the wireless tag reading device 1. The item registration process is a process of reading item information of an item M from an item master (not shown) based on the received individual item code and displaying the item name of the item M and the price of the item. In addition, the payment process refers to a process of displaying the total amount of registered items M and performing a payment related to the transaction using the payment method designated by the customer.

The wireless tag reading device 1 receives tag information related to the item M from the wireless tag 6 attached to the item M purchased by the customer. Then, the wireless tag reading device 1 transmits the individual item code included in the received tag information to the POS terminal 3. The POS terminal 3 executes an item registration process for the item M based on the received item code, and executes a payment process related to the transaction.

Next, a structure and configuration of the wireless tag reading device 1 will be described. FIG. 2 is a schematic diagram for explaining a structure of the wireless tag reading device 1. FIG. 3 is a schematic diagram of the wireless tag reading device 1 mounted on a holding table 4. As illustrated in FIG. 2, the wireless tag reading device 1 includes a grip 11 and a main body 12 provided on an upper portion of the grip 11. The grip 11 is a part for an operator to grasp and hold the wireless tag reading device 1. Further, the main body 12 transmits radio waves toward a wireless tag 6, and reads tag information from the wireless tag 6.

A switch 5 is attached to the grip 11. The switch 5 can be operated by, for example, a hand (for example, an index finger) holding the grip 11, and is turned on when the grip is strongly held, and is turned off when the grip is weakened.

An antenna 33 is attached to a distal end portion 14 of the main body 12. The antenna 33 is formed in, for example, a substantially rectangular planar shape. The antenna 33 transmits a radio wave from the distal end portion 14 to the outside. Further, the antenna 33 receives a response wave including tag information from the wireless tag 6. FIG. 2 shows the wireless tag reading device 1 in a state in which the wireless tag reading device 1 is removed from the holding table 4, which will be described later, and when the switch 5 is turned on, the wireless tag reading device 1 transmits radio waves from the antenna 33.

A magnetic sensor 39 is embedded in a bottom portion of the grip 11. The magnetic sensor 39 outputs a signal when detecting a magnet nearby. That is, the magnetic sensor 39 outputs a signal indicating that a magnet is present when the magnet is present within a predetermined distance.

FIG. 3 shows a state in which the wireless tag reading device 1 is attached to the holding table 4. As shown in FIG. 3, the holding table 4 includes a base plate 41 and a pair of columns 42. The base plate 41 is a substantially rectangular flat plate-like member. The pair of columns 42 are substantially rectangular parallelepiped columns extending upward from the base plate 41. The pair of columns 42 are erected at intervals that allow the wireless tag reading device 1 to be mounted therebetween. A flat magnet 43 is embedded in the base plate 41.

The column 42 detachably supports the wireless tag reading device 1 with respect to the holding table 4. The wireless tag reading device 1 is attached to the holding table 4 and supported by the column 42. The wireless tag reading device 1 mounted on the holding table 4 is held so that the antenna 33 always faces in one direction. When the wireless tag reading device 1 is mounted on the holding table 4, the antenna 33 faces, for example, a direction of a basket holding area in which a shopping basket is placed and held (not shown).

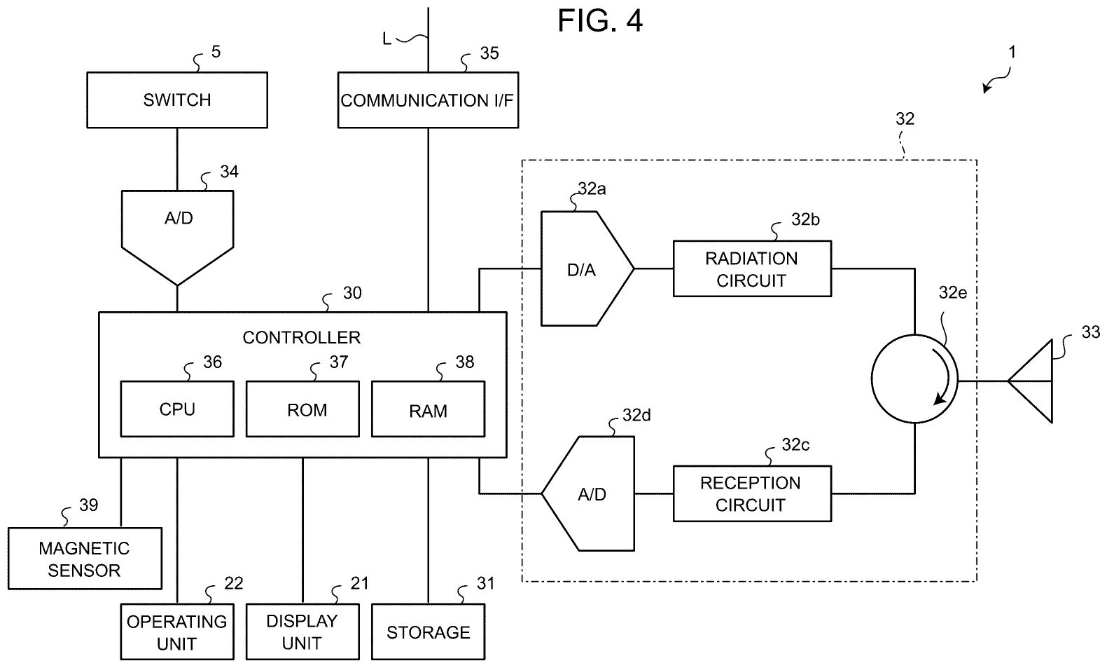

In addition, in a state in which the wireless tag reading device 1 is mounted on the holding table 4, the magnet 43 embedded in the base plate 41 and the magnetic sensor 39 embedded in the bottom portion of the grip 11 are closest to each other, and the magnetic sensor 39 outputs a signal indicating that the magnet 43 is present in the vicinity. That is, when the wireless tag reading device 1 is mounted on the holding table 4, the magnetic sensor 39 is close to the magnet 43 within the predetermined distance, and thus outputs a signal indicating that the magnet 43 is present in the vicinity. A control unit 30 to which this signal is input (see FIG. 4) determines that the wireless tag reading device 1 is mounted on the holding table 4.

Further, the wireless tag reading device 1 increases the power of the radio wave transmitted from the antenna 33 so that the radio wave reaches the wireless tags 6 of items M placed in the basket in the basket holding area which is slightly separated from the holding table 4. In addition, the wireless tag reading device 1 increases (for example, 160 kbps) the transmission speed of the transmitted radio wave in order to read multiple wireless tags 6 located in the basket placing portion (that is, stored in the basket). By increasing the transmission speed, the tag information can be received from many wireless tags 6 at once in a short period of time (for example, the speed for receiving the tag information from the wireless tags 6 is 320 kbps). The wireless tag reading device 1 mounted on the holding table 4 operates as a fixed reading device.

Further, the wireless tag reading device 1 mounted on the holding table 4 can be removed from the holding table 4. When the wireless tag reading device 1 is removed from the holding table 4, the magnetic sensor 39 is separated from the magnet 43 by a predetermined distance or more. In this state, the magnetic sensor 39 outputs a signal indicating that the magnet 43 is not present in the vicinity. Therefore, the control unit 30 determines that the wireless tag reading device 1 has been removed from the holding table 4. The wireless tag reading device 1 removed from the holding table 4 is a handheld reading device.

In the state in which the wireless tag reading device 1 is removed from the holding table 4, the operator grasps the grip 11 of the wireless tag reading device 1, brings the wireless tag reading device 1 (i.e., the antenna 33) close to the wireless tag 6 attached to the item M placed on the lower stage of a shopping cart, presses the switch 5 to turn on the switch 5 to transmit a radio wave toward the wireless tag 6, and receives the tag information transmitted from the wireless tag 6. In this way, the wireless tag reading device 1 reads the tag information from the wireless tag 6 attached to the approaching item M. When the finger is released from the switch 5, the switch 5 is turned off, and the transmission of radio waves from the antenna 33 is stopped. That is, the wireless tag reading device 1 removed from the holding table 4 transmits radio waves from the antenna 33 only while the switch 5 is operated to the ON state. Further, in a state in which the wireless tag reading device 1 is attached to the holding table 4 (i.e., the magnetic sensor 39 outputs a signal that detects the magnet 43), radio waves are transmitted from the antenna 33 irrespective of the operation of the switch 5. For example, when detecting that the basket is placed in the basket holding area, the wireless tag reading device 1 may transmit a radio wave from the antenna 33 to the holding table 4. Further, for example, in a state where the magnetic sensor 39 is outputting a signal that has detected the magnet 43, it may transmit a radio wave from the antenna 33 at all times.

The wireless tag reading device 1 removed from the holding table 4 can face any direction. Therefore, the antenna 33 may not always be oriented in one direction. The wireless tag reading device 1 in such a state may erroneously read the wireless tag 6 attached to an item M other than the target item M depending on the orientation of the wireless tag reading device 1. Further, the wireless tag reading device 1 removed from the holding table 4, in order to read the wireless tag 6 of the one item M that is targeted, since the radio wave should be delivered to the wireless tag 6 attached to the item M, the output power of the radio wave transmitted from the antenna 33 is smaller than the output power used when the wireless tag reading device 1 is attached to the holding table 4. Further, the wireless tag reading device 1 removed from the holding table 4 reads the wireless tag 6 of one particular item M, so that the transmission speed of the information by the transmitted radio wave is slower (for example, 40 kbps) than the transmission speed used when the wireless tag reading device 1 is attached to the holding table 4. Since there is only one wireless tag 6 that reads even if the transmission speed of the information is decreased, the tag information can be sufficiently received (for example, the speed for receiving the tag information from the wireless tag 6 is 25 kbps).

The frequency band to be used can be narrowed by reducing the transmission speed of the information in a state where the wireless tag reading device 1 is removed from the holding table 4. Therefore, when there is a similar wireless tag reading device 1 nearby, e.g., when there are a plurality of cart POS terminals each having its own wireless tag reading device 1 on the shopping cart, a large number of channels can be secured so as not to cause interference with other wireless tag reading devices 1.

Here, the wireless tag reading device 1 is provided with the magnetic sensor 39 and the holding table 4 is provided with the magnet 43, but the wireless tag reading device 1 may be provided with the magnet 43 and the holding table 4 may be provided with the magnetic sensor 39. Alternatively, a sensor other than the magnetic sensor 39 and the magnet 43 (for example, an optical sensor or a mechanical sensor) may be used to detect attachment and detachment of the wireless tag reading device 1 to and from the holding table 4. Further, the wireless tag reading device 1 and the holding table 4 are installed together with the POS terminal 3 installed in the checkout area of the store, or are mounted on a cart POS.

Next, a hardware configuration of the wireless tag reading device 1 will be described. FIG. 4 is a block diagram illustrating a hardware configuration of the wireless tag reading device 1. As illustrated in FIG. 4, the wireless tag reading device 1 includes a processing circuit such as a central processing unit (CPU) 36, a read only memory (ROM) 37, a random access memory (RAM) 38, a storage device 31 (for example, a hard disc drive (HDD)), a flash memory, and the like. The ROM 37 stores various programs. The RAM 38 temporarily stores programs and various types of data. The storage device 31 stores various programs. The CPU 36, the ROM 37, the RAM 38, the storage device 31 are connected to each other via buses (not shown). The CPU 36, the ROM 37, and the RAM 38 constitute the controller 30. That is, the controller 30 executes a control process related to the wireless tag reading device 1, which will be described later, in accordance with a control program stored in the ROM 37 or the storage device 31 and loaded into the RAM 38.

The controller 30 is connected to a display unit 21, an operating unit 22, a radio unit 32, a communication interface (I/F) 35, and the magnetic sensor 39 described above. The controller 30 is also connected to an analog-to-digital (A/D) converter 34 that converts the analog output from the switch 5 to a digital value. When determining that the wireless tag reading device 1 is removed from the holding table 4, the controller 30 causes the antenna 33 to transmit a radio wave for collecting information stored in the wireless tag 6 when an on signal is input due to the switch 5 being turned on. Further, when it is determined that the wireless tag reading device 1 is removed from the holding table 4, when an off signal is input due to the switch 5 being turned off, the radio wave transmitted from the antenna 33 is stopped.

The radio unit 32 includes a digital-to-analog (D/A) converter 32a, a radiation circuit 32b, a reception circuit 32c, an A/D converter 32d, and a transmission/reception switch 32e. The D/A converter 32a converts the radiation data and the control data from the controller 30 into an analog signal and supplies the signal to the radiation circuit 32b.

The radiation circuit 32b adjusts or changes the output power and modulates the input radiating data. The radiation circuit 32b also outputs the modulated signal to the antenna 33 via the transmission/reception switch 32e that switches between radiation and reception at the adjusted or modified output. On the other hand, a reply signal including tag information from the wireless tag 6 received by the antenna 33 is supplied to the reception circuit 32c via the transmission/reception switch 32e. Then, the reception circuit 32c demodulates the response signal, and the A/D converter 32d A/D converts the demodulated response signal and passes it to the controller 30.

The communication I/F 35 is a network interface controller that is connected to the POS terminal 3 via the connection line L, transmits the received tag information to the POS terminal 3, and receives the information from the POS terminal 3.

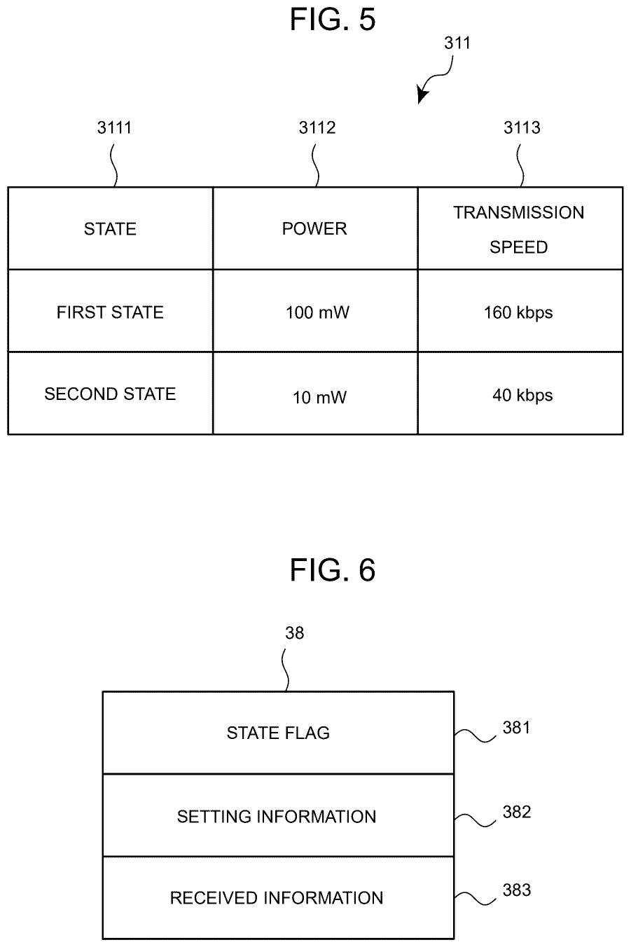

Next, a state storage table 311 stored in the storage device 31 will be described. FIG. 5 depicts a data structure of the state storage table 311. The state storage table 311 stores the output power of the radio wave transmitted from the antenna 33 (that is, the power output by the radiation circuit 32b to the antenna 33) and the transmission speed of the information output by the radiation circuit 32b to the antenna 33 in the state where the wireless tag reading device 1 is mounted on the holding table 4 and in the state where it is removed from the holding table 4. The state storage table 311 includes a state field 3111, a power field 3112, and a transmission speed field 3113. The state field 3111 stores states of the wireless tag reading device 1 (i.e., the state in which the wireless tag reading device 1 is attached to the holding table 4 and the state in which the wireless tag reading device 1 is detached from the holding table 4). The power field 3112 stores the power of the radio wave to be transmitted from the antenna 33 in accordance with the conditions of the wireless tag reading device 1. For example, the power field 3112 stores “100 mW” of the radio wave transmitted from the antenna 33 in the state corresponding to the first state in which the wireless tag reading device 1 is attached to the holding table 4. In addition, in the second state in which the wireless tag reading device 1 is removed from the holding table 4, the power field 3112 stores “10 mW” in this example. Any wattage can be set for the first and second states depending on the application for which the wireless tag reading device 1 is used.

In addition, the transmission speed field 3113 stores the transmission speed of the information to be carried on the radio waves transmitted from the antenna 33, i.e., the transmission speed of the information outputted by the radiation circuit 32b to the antenna 33, corresponding to the states of the wireless tag reading device 1. For example, in the first state in which the wireless tag reading device 1 is mounted on the holding table 4, the transmission speed field 3113 stores “160 kbps”. In addition, in the second state in which the wireless tag reading device 1 is removed from the holding table 4, the transmission speed field 3113 stores “40 kbps” in this example. Any transmission speed can be set for the first and second states depending on the application for which the wireless tag reading device 1 is used.

Next, the data stored in the RAM 38 will be described. FIG. 6 depicts data to be stored in the RAM 38. As illustrated in FIG. 6, the RAM 38 stores a state flag 381, setting information 382, and received information 383. The state flag 381 indicates whether the wireless tag reading device 1 is attached to the holding table 4 (i.e., in the first state) or detached from the holding table 4 (i.e., in the second state). In the case where the wireless tag reading device 1 is mounted on the holding table 4, i.e., in the case where the controller 30 determines that the magnetic sensor 39 is outputting a signal indicating that the magnet 43 has been detected, the state flag 381 is set to be “1”, for example. When the wireless tag reading device 1 is removed from the holding table 4, i.e., when the controller 30 determines that the magnetic sensor 39 is outputting a signal indicating that the magnet 43 is not detected, the state flag 381 is set to be “0”, for example.

The setting information 382 includes the value of the power extracted from the power field 3112 and the transmission speed extracted from the transmission speed field 3113 (that is, the power and the transmission speed output by the radiation circuit 32b to the antenna 33) in accordance with the state flag 381. Specifically, in a case where “1” is stored in the state flag 381, the value of the power for increasing the power of the radio wave transmitted from the antenna 33 is extracted from the power field 3112 and stored in the setting information 382, and the high transmission speed is extracted from the transmission speed field 3113 and stored in the setting information 382. Further, when “0” is stored in the state flag 381, the value of the power to be smaller than the case of the flag “1” is extracted from the power field 3112 and stored in the setting information 382, and the transmission speed lower than the case of the flag “1” is extracted from the transmission speed field 3113 and stored in the setting information 382.

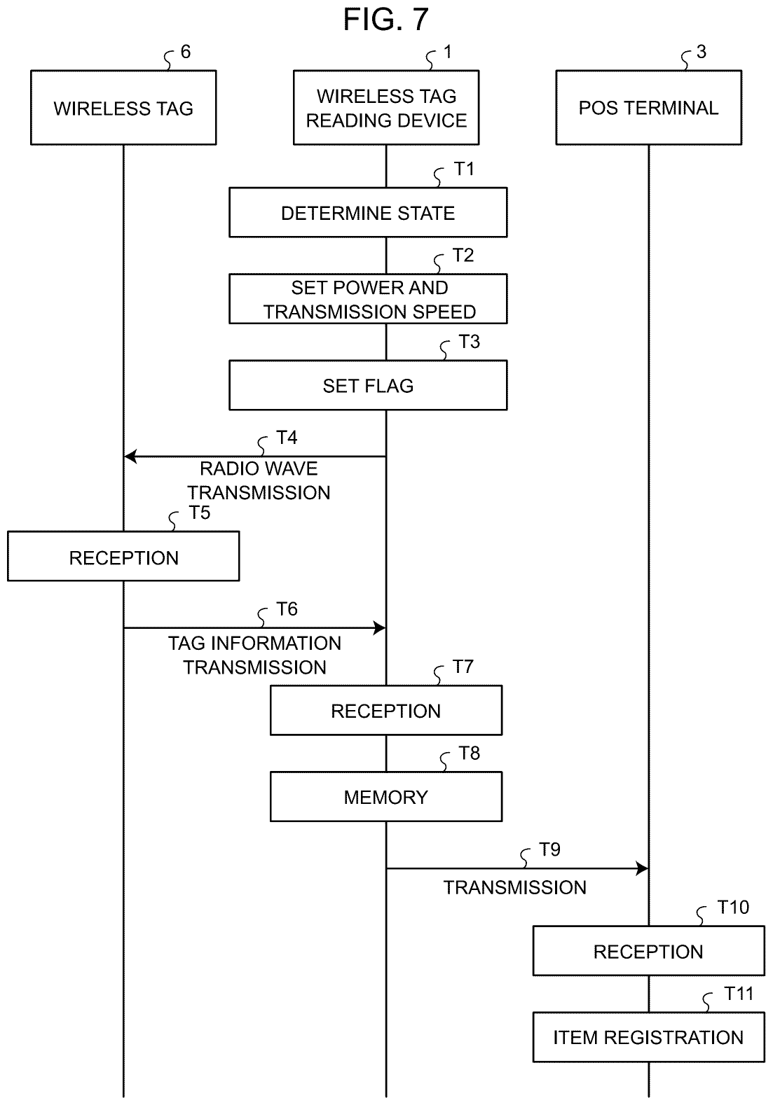

The flow of processes and information transmission between the wireless tag 6, the wireless tag reading device 1, and the POS terminal 3 will now be described. FIG. 7 is a sequence diagram showing a flow of processes and information-transmission/reception between the wireless tag 6, the wireless tag reading device 1, and the POS terminal 3. As shown in FIG. 7, the wireless tag reading device 1 determines whether it is attached to the holding table 4 (i.e., the first state) or detached from the holding table 4 (i.e., the second state) on the basis of an output from the magnetic sensor 39 (T1). Then, the wireless tag reading device 1 reads the value of the power suitable for the state (i.e., the output of the radio wave transmitted from the antenna 33) from the power field 3112, stores it in the setting information 382 (T2), reads the transmission speed suitable for the current state from the transmission speed field 3113, and stores it in the setting information 382 (T2). Then, the wireless tag reading device 1 stores a state flag 381 indicating the first state or the second state (T3). Then, the wireless tag reading device 1 transmits radio waves from the antenna 33 using the power and the transmission speed stored in the setting information 382 (T4).

The wireless tag 6 attached to the item M receives radio waves transmitted from the antenna 33 (T5). Then, the wireless tag 6 transmits a response wave including the tag information stored in the wireless tag 6 responsive to the received radio wave (T6).

The wireless tag reading device 1 receives a response wave including tag information transmitted from the wireless tag 6 (T7). Then, the wireless tag reading device 1 stores the received tag information in the received information 383 (T8). Then, the wireless tag reading device 1 transmits the tag information stored in the received information 383 to the POS terminal 3 (T9).

The POS terminal 3 receives tag information transmitted from the wireless tag reading device 1 (T10). Then, the POS terminal 3 executes the item registration process of the item M on the basis of the individual item code included in the received tag information (e.g., the item code for specifying the type of the item M) (T11).

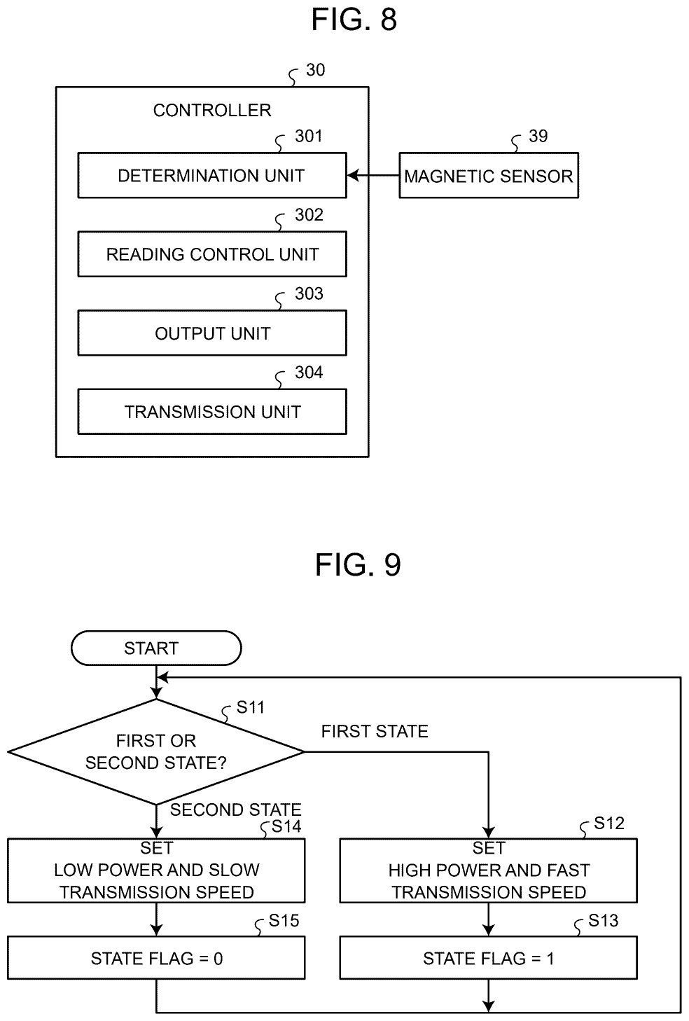

Hereinafter, a functional configuration of the wireless tag reading device 1 will be described. FIG. 8 is a functional block diagram illustrating a functional configuration of the wireless tag reading device 1. The controller 30 functions as a determination unit 301, a reading control unit 302, an output unit 303, and a transmission unit 304 by executing various programs and a control program stored in the ROM 37 and/or the storage device 31.

The determination unit 301 determines whether the wireless tag reading device 1 is in the first state in which the wireless tag reading device 1 is attached to the holding table 4 or in the second state in which the wireless tag reading device 1 is detached from the holding table 4. In one embodiment, the determination unit 301 determines whether the wireless tag reading device 1 is in the first state or the second state based on the output from the magnetic sensor 39. Specifically, when the magnetic sensor 39 has output a signal indicating that the magnet 43 has been detected, the determination unit 301 determines that the wireless tag reading device 1 is in the first state in which the wireless tag reading device 1 is attached to the holding table 4. In addition, when the magnetic sensor 39 has output a signal indicating that the magnet 43 is not detected, the determination unit 301 determines that the wireless tag reading device 1 is in the second state in which the wireless tag reading device 1 is detached from the holding table 4.

The reading control unit 302 changes the intensity of the output power for reading the information of the item M between the first state and the second state. In one embodiment, the reading control unit 302 sets the output of the radio wave transmitted from the antenna 33 to the wireless tag 6 to be larger when the wireless tag reading device 1 is in the first state, and sets the output of the radio wave transmitted from the antenna 33 to the wireless tag 6 to be smaller than the first state when the wireless tag reading device 1 is in the second state. Specifically, the reading control unit 302 increases the power output by the radiation circuit 32b to the antenna 33 when the wireless tag reading device 1 is in the first state, and sets the power output by the radiation circuit 32b to the antenna 33 to be smaller than that in the first state when the wireless tag reading device 1 is in the second state.

Further, the reading control unit 302 sets the transmission speed of the information included in the output radio wave to be high when the wireless tag reading device 1 is in the first state, and sets the transmission speed of the information included in the output radio wave to be low when the wireless tag reading device 1 is in the second state. Specifically, the reading control unit 302 sets the transmission speed of the information that the radiation circuit 32b outputs to the antenna 33 to be high when the wireless tag reading device 1 is in the first state, and sets the transmission speed of the information that the radiation circuit 32b outputs to the antenna 33 to be low when the wireless tag reading device 1 is in the second state.

The output unit 303 causes a radio wave to be emitted from the antenna 33 using the power and transmission speed set by the reading control unit 302. In one embodiment, the output unit 303 controls the antenna 33 to output a radio wave at the power and speed set by the reading control unit 302.

In the first state and the second state, the transmission unit 304 transmits the tag information about the item M received by the antenna 33 to the POS terminal 3. In one embodiment, the transmission unit 304 controls the communication I/F 35 to transmit the item code received by the antenna 33 to the POS terminal 3 in the first state and the second state.

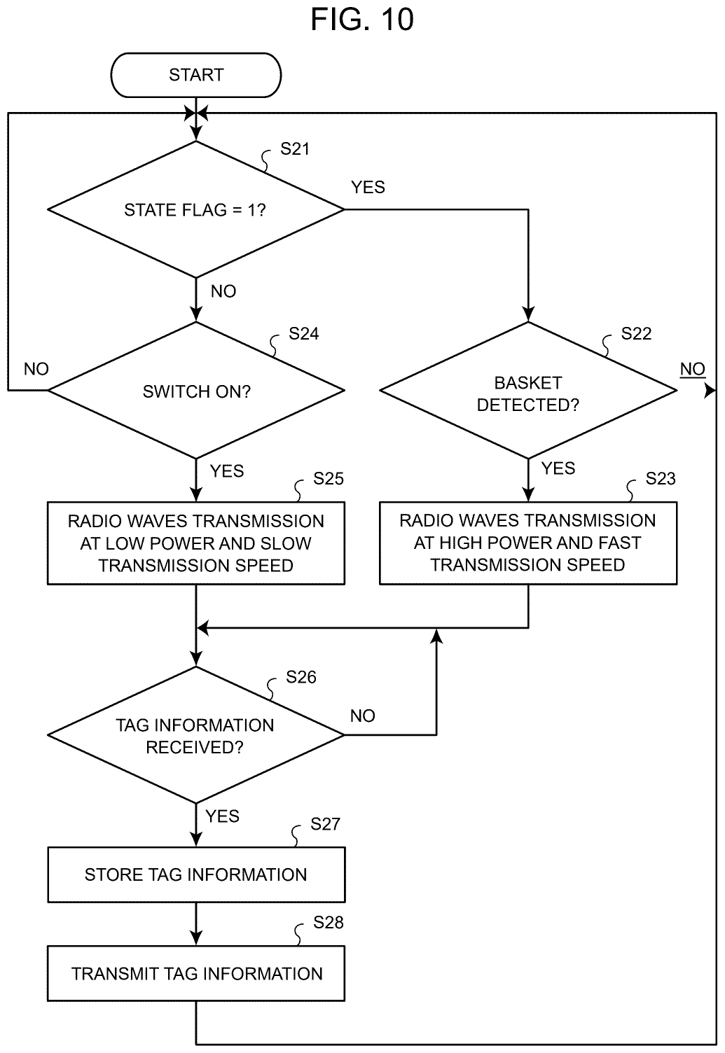

Next, the control of the wireless tag reading device 1 will be described. FIG. 9 and FIG. 10 are flowcharts showing a control process performed by the wireless tag reading device 1. As illustrated in FIG. 9, the determination unit 301 of the wireless tag reading device 1 determines whether the wireless tag reading device 1 is in the first state in which the wireless tag reading device 1 is attached to the holding table 4 or the second state in which the wireless tag reading device 1 is detached from the holding table 4 based on the output of the magnetic sensor 39 (S11). When it is determined that the wireless tag reading device 1 is in the first state (the first state of S11), the reading control unit 302 acquires information on a value of power having a large output value from the power field 3112 corresponding to the first state stored in the state field 3111 and stores the information in the setting information 382 (S12). In addition, the reading control unit 302 acquires information of a fast transmission speed from the transmission speed field 3113 corresponding to the first state stored in the state field 3111 and stores the information in the setting information 382 (S12). Then, the controller 30 set “1” to the state flag 381 (S13). Then, the controller 30 returns to S11.

When it is determined that the wireless tag reading device 1 is in the second state (the second state of S11), the reading control unit 302 acquires information on the value of the power whose output value is smaller than the first state from the power field 3112 corresponding to the second state stored in the state field 3111 and stores the information in the setting information 382 (S14). In addition, the reading control unit 302 acquires information of a transmission speed slower than the first state from the transmission speed field 3113 corresponding to the second state stored in the state field 3111 and stores the information in the setting information 382 (S14). Then, the controller 30 sets “0” to the state flag 381 (S15). Then, the controller 30 returns to S11.

Further, as illustrated in FIG. 10, the controller 30 determines whether the flag “1” is stored in the state flag 381 (S21). When it is determined that the flag “1” is stored (Yes at S21), the controller 30 determines whether the basket containing the item M is placed in the basket holding area (S22). For example, a basket sensor for detecting the presence or absence of a basket (not shown) is provided in the basket holding area, and when the basket sensor detects a basket, the controller 30 determines that the basket is placed. When it is determined that the basket containing the item M is not placed in the basket holding area (No at S22), the controller 30 returns to S21, and when it is determined that the basket containing the item M is placed in the basket holding area (Yes at S22), the output unit 303 drives the radiation circuit 32b to transmit radio waves from the antenna 33 at a high power output and a fast transmission speed stored in the setting information 382 (S23).

When it is determined that the flag “0” is stored (No at S21), the controller 30 determines whether the switch 5 is on (S24). When it is determined that the switch 5 is off, the process returns to S21 (No at S24), and when it is determined that the switch 5 is on (Yes of S24), the output unit 303 drives the radiation circuit 32b to transmit radio waves from the antenna 33 at a low power output and a slow transmission speed stored in the setting information 382 (S25).

When S23 process or S25 process is completed, the controller 30 determines whether a response wave including the tag information transmitted from the wireless tag 6 is received from the antenna 33 (S26). If it is determined that a response wave including the tag information has been received (No at S26), the controller 30 stores the received tag information including the item code in the received information 383 (S27). That is, the received information 383 stores all the pieces of tag information received by the antenna 33 in response to the radio waves transmitted in S23 process or S25 process. Then, the transmission unit 304 transmits the item code stored in the received information 383 to the POS terminal 3 (S28). Then, the controller 30 returns to S21.

The wireless tag reading device 1 determines whether it is in the first state in which the wireless tag reading device 1 is attached to the holding table 4 or in the second state in which the wireless tag reading device 1 is detached from the holding table 4. In the first state, since the wireless tag reading device 1 is mounted on the holding table 4, the radio wave whose power of the radio wave transmitted from the antenna 33 is increased and the transmission speed of information is increased is transmitted from the antenna 33 so that the wireless tag reading device 1 can read the wireless tag 6 attached to an item M placed in a basket in a basket holding area slightly apart from the wireless tag reading device 1. In the second state, since the wireless tag reading device 1 is detached from the holding table 4 (i.e., held by a human hand), the power of the radio wave transmitted from the antenna 33 is made smaller than that in the first state, and the transmission speed of information is made slower than that in the first state so that only the wireless tag 6 attached to the target item M can be read. The wireless tag reading device 1 having such a configuration, when mounted on the holding table 4, it is possible to collectively read the tag information transmitted from the wireless tags 6 attached to a plurality of item M placed in the basket which is somewhat distant, when removed from the holding table 4, by bringing the wireless tag reading device 1 closer to the target item M, it is possible to read the tag information of the item M, it is possible to reduce the risk of erroneously reading the tag information of the unintended surrounding item M. That is, the wireless tag reading device 1 is a hybrid reading device that can operate as both a fixed reading device and a handheld reading device. Since it is not necessary for a store to provide both such a fixed wireless tag reading device and a handheld wireless tag reading device, the space in the checkout lane can be reduced.

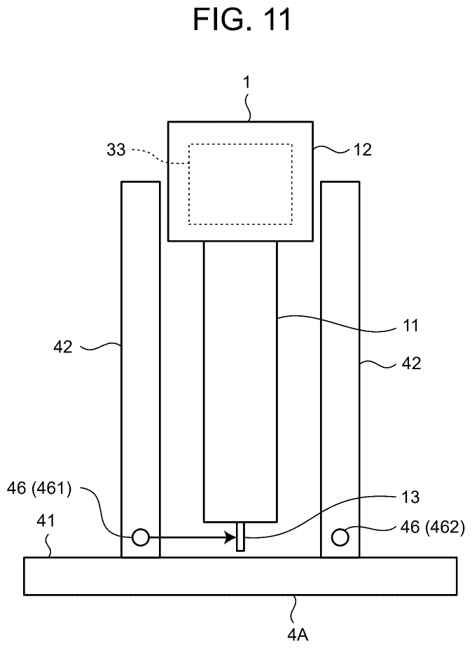

Modifications of the above-described embodiments will now be described. FIG. 11 is a diagram illustrating a modification to the wireless tag reading device 1. In the following description of the modification examples, the same reference numerals are given to the same configurations as those in the above-described embodiments, and the description thereof may be omitted or simplified. The modified wireless tag reading device 1 does not include any magnetic sensor 39. Instead, a light shielding plate 13 that shields light is provided at the bottom of the grip 11. Further, the holding table of the modified example is referred to as the holding station 4A and does not include any magnet 43. Instead, a transmissive optical sensor 46 is provided. The optical sensor 46 includes a light emitting unit 461 that emits light, and a light receiving unit 462 that receives the light emitted by the light emitting unit 461.

In the case of the second state in which the wireless tag reading device 1 is removed from the holding station 4A, the light receiving unit 462 receives the light emitted from the light emitting unit 461. On the other hand, when the wireless tag reading device 1 is mounted on the holding station 4A, the light shielding plate 13 is positioned in the passage of light. Therefore, the light emitted from the light emitting unit 461 is blocked by the light shielding plate 13, and the light receiving unit 462 does not receive the light emitted from the light emitting unit 461. The optical sensor 46 outputs different signals depending on whether the light receiving unit 462 receives the light emitted from the light emitting unit 461. That is, the optical sensor 46 outputs a signal that can detect whether the light receiving unit 462 is receiving or not receiving the light emitted from the light emitting unit 461.

Note that, in the modified example, the optical sensor 46 is attached to the wireless tag reading device 1 and the light shielding plate 13 is attached to the holding station 4A, but when the optical sensor 46 is attached to the grip 11 of the wireless tag reading device 1, the light emitted from the optical sensor 46 is shielded by the hand holding the grip 11, and there is a possibility that the wireless tag reading device 1 is erroneously recognized as being attached to the holding station 4A, so that the light shielding plate 13 is attached to the wireless tag reading device 1, and the optical sensor 46 is preferably attached to the holding table 4.

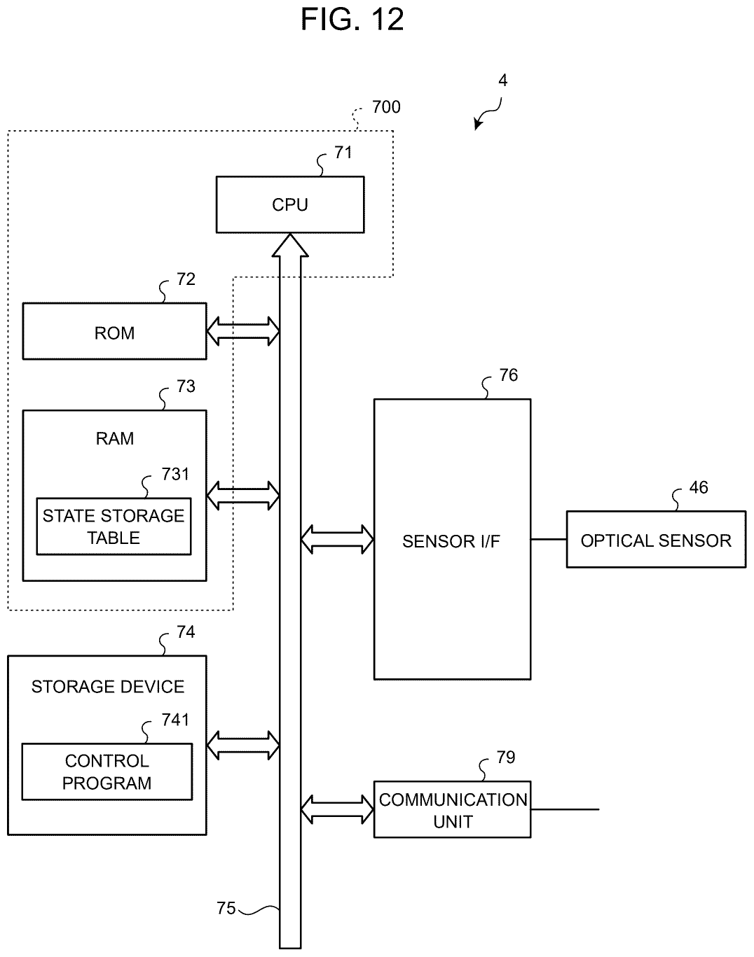

Next, a hardware configuration of the holding station 4A according to the modification will be described. FIG. 12 is a block diagram illustrating a hardware configuration of the holding station 4A. As illustrated in FIG. 12, the holding station 4A includes a CPU 71, a ROM 72, a RAM 73, a storage device 74, and the like. The ROM 72 stores various programs. The RAM 73 temporarily stores programs and various types of data. The storage device 74 stores various programs. The CPU 71, the ROM 72, the RAM 73, the storage device 74 are connected to each other via a bus 75. The CPU 71, the ROM 72, and the RAM 73 constitute a controller 700. That is, the controller 700 executes a control process related to the holding station 4A, which will be described later, in accordance with a control program stored in the ROM 72 or the storage device 74 and loaded into the RAM 73.

The optical sensor 46 is connected to the controller 700 via a sensor I/F 76. The optical sensor 46 includes the light emitting unit 461 and the light receiving unit 462, and outputs light emitted from the light emitting unit 461 differently between a case where the light receiving unit 462 receives light and a case where the light is not received. When the light receiving unit 462 receives light emitted from the light emitting unit 461, a signal (for example, an High (H) signal) indicating that the light receiving unit 462 is receiving light is output, and when the light receiving unit 462 does not receive light, a signal (for example, an Low (L) signal) indicating that the light receiving unit 462 is not receiving light is output. The controller 700 detects that the wireless tag reading device 1 is removed from the holding station 4A when the output from the optical sensor 46 is H, and detects that the wireless tag reading device 1 is attached to the holding station 4A when the output from the optical sensor 46 is L (that is, when the light is blocked by the light shielding plate 13).

The controller 700 is connected to a communication unit 79 via the bus 75. The communication unit 79 is connected to the wireless tag reading device 1 via a communication line or wirelessly (not shown), and transmits information related to the output of the optical sensor 46 to the wireless tag reading device 1.

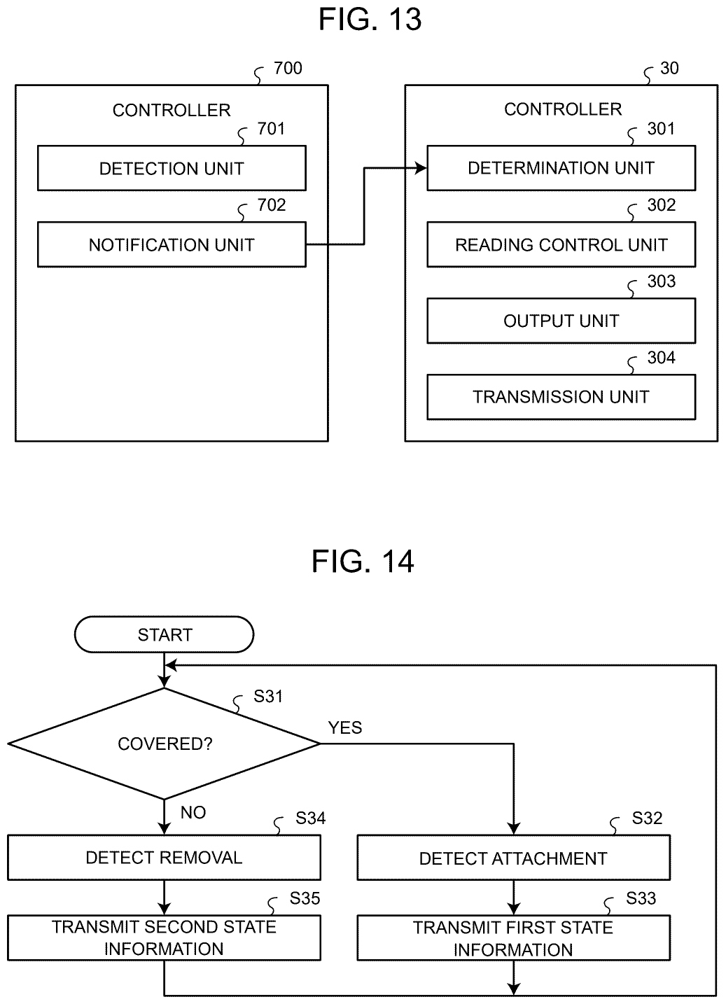

The functional configuration of the modified wireless tag reading device 1 will now be described. FIG. 13 is a functional block diagram illustrating a functional configuration of the wireless tag reading device 1 and the holding station 4A according to the modification. The controller 700 of the holding station 4A functions as the detection unit 701 and the notification unit 702 according to various programs and a control program stored in the ROM 72 and/or the storage device 74.

The detection unit 701 detects whether the wireless tag reading device 1 is attached to the holding station 4A or whether the wireless tag reading device 1 is detached from the holding station 4A based on an output signal from the optical sensor 46. In an embodiment, the detection unit 701 detects that the wireless tag reading device 1 is removed from the holding station 4A when the output signal from the optical sensor 46 is H, for example, and detects that the wireless tag reading device 1 is attached to the holding station 4A when the output signal from the optical sensor 46 is L, for example.

When the detection unit 701 detects that the wireless tag reading device 1 is removed from the holding station 4A, the notification unit 702 transmits information (i.e., second state information) indicating that the wireless tag reading device 1 is removed from the holding station 4A to the wireless tag reading device 1 by the detection unit 701. In addition, when the detection unit 701 detects that the wireless tag reading device 1 is attached to the holding station 4A, the notification unit 702 transmits information (first state information) indicating that the wireless tag reading device 1 is attached to the holding station 4A to the wireless tag reading device 1 by the detection unit 701.

The controller 30 of the wireless tag reading device 1 according to the modification functions as the determination unit 301, the reading control unit 302, the output unit 303, and the transmission unit 304 according to various programs a control program stored in the ROM 37 and/or the storage device 31. Since the functional configurations of the determination unit 301, the reading control unit 302, the output unit 303, and the transmission unit 304 are basically the same as those described with reference to FIG. 8, the description thereof will be omitted. However, the determination unit 301 determines whether the wireless tag reading device 1 is in the first state in which the wireless tag reading device 1 is attached to the holding station 4A or the second state in which the wireless tag reading device 1 is detached from the holding station 4A based on the information transmitted by the notification unit 702.

Control of the holding station 4A will now be described. FIG. 14 is a flowchart showing a control process of the holding station 4A. As illustrated in FIG. 14, the controller 700 of the holding station 4A determines whether the optical sensor 46 is covered by the light shielding plate 13 (i.e., whether the L signal is output from the optical sensor 46) or the optical sensor 46 is covered by the light shielding plate 13 (i.e., whether the H signal is output from the optical sensor 46) (S31). When it is determined that the optical sensor 46 is covered by the light shielding plate 13 (Yes at S31), the detection unit 701 detects that the wireless tag reading device 1 is attached to the holding station 4A (S32). Then, the notification unit 702 transmits first state information indicating that the wireless tag reading device 1 is attached to the holding station 4A to the wireless tag reading device 1 (S33). Then, the controller 700 returns to S31.

When it is determined that the optical sensor 46 is not covered by the light shielding plate 13 (No at S31), the detection unit 701 detects that the wireless tag reading device 1 is removed from the holding station 4A (S34). Then, the notification unit 702 transmits second state information indicating that the wireless tag reading device 1 is removed from the holding station 4A to the wireless tag reading device 1 (S35). Then, the controller 700 returns to S31.

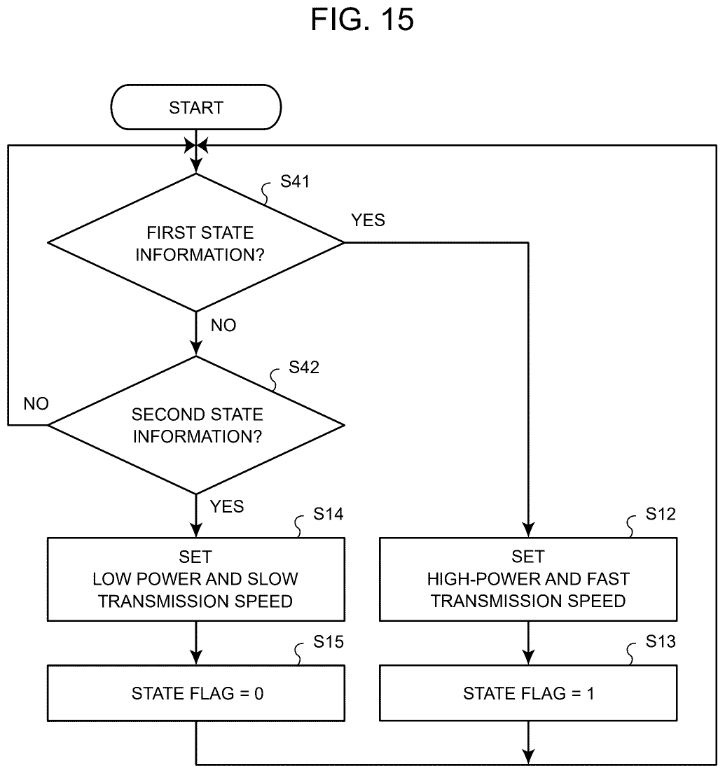

Next, the control of the wireless tag reading device 1 according to the modification will be described. FIG. 15 is a flowchart illustrating a control process performed by the wireless tag reading device 1 according to the modification. In the control of the wireless tag reading device 1 shown in FIG. 15, the control equivalent to the control shown in FIG. 9 is denoted by the same reference numerals as in FIG. 9, and description thereof will be omitted.

In FIG. 15, the determination unit 301 determines whether the first state information is received from the holding station 4A (S41). When it is determined that the first state information has been received (Yest at S41), the reading control unit 302 returns to S41 by executing S12 process and S13 process.

When it is determined that the first state information is not received (No at S41), the determination unit 301 determines whether the second state information is received from the holding station 4A (S42). When it is determined that the second state information has been received (Yes at S42), the reading control unit 302 executes S14 process and S15 process, and returns to S41.

The wireless tag reading device 1 according to this modification determines whether it is in the first state in which the wireless tag reading device 1 is attached to the holding station 4A or in the second state in which the wireless tag reading device is removed from the holding station 4A based on a signal from the holding station 4A. In the first state, since the wireless tag reading device 1 is mounted on the holding station 4A, the radio waves transmitted from the antenna 33 with increased power and information transmission speed are transmitted from the antenna 33 so that wireless tag reading device 1 can read the wireless tag 6 attached to an item M in a basket placed on the basket holding area slightly apart from the wireless tag reading device 1. In the second state, since the wireless tag reading device 1 is removed from the holding station 4A (i.e., held by a human hand), a radio wave whose power of the radio wave transmitted from the antenna 33 is made smaller than that in the first state and the transmission speed of information is made slower than that in the first state is transmitted from the antenna 33 as an output capable of reading the wireless tag 6 attached only to the targeted item M. The wireless tag reading device 1 having such a configuration, when mounted on the holding station 4A, can collectively read tag information transmitted from the wireless tags 6 attached to a plurality of items M placed in a basket placed on a placing table somewhat distant from each other at high speed. When the wireless tag reading device 1 is removed from the holding station 4A, tag information of the item M can be read by bringing the wireless tag reading device 1 close to the targeted item M, and the possibility of erroneously reading tag information of the surrounding item M can be reduced. That is, the wireless tag reading device 1 is a hybrid reading device that can operate as both a fixed reading device and a handheld reading device. Further, since it is not necessary to provide such a fixed wireless tag reading device and a handheld wireless tag reading device, a space for a checkout lane can be reduced.

As described above, the wireless tag reading device 1 includes the wireless tag reading device 1 that reads information of an item M, the determination unit 301 that determines whether the wireless tag reading device 1 is in the first state in which the wireless tag reading device 1 is mounted on the holding table 4 or station 4A or in the second state in which the wireless tag reading device 1 is removed from the holding table 4 or station 4A, the reading control unit 302 that changes the magnitude of the output for reading the information of the item M between the first and second states, and the output unit 303 that outputs the changed size.

The wireless tag reading device 1 is a hybrid reading device that can operate as a fixed reading device and a handheld reading device.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

For example, in the above-described examples, whether the wireless tag reading device 1 is mounted on the holding table 4 is detected by using the magnetic sensor 39 and the magnet 43, and in the modified example, the wireless tag reading device 1 is detected by using the optical sensor 46 and the light shielding plate 13. However, when the wireless tag reading device 1 is attached to the holding table 4, a physical switch may be provided and configured to be on (i.e., an output of a switch signal indicating that it is on) or, off (i.e., an output of a signal indicating that it is off) depending on whether the wireless tag reading device 1 is on the holding table 4.

Further, in the above-described examples, the item M has been described as an example of an item sold at a store. However, embodiments of the present disclosure are not limited thereto, and the item M may be any object to be read by a reading device.

Further, the wireless tag reading device 1 has been described as an example of a reading device. However, embodiments of the present disclosure are not limited thereto, and the reading device may be an optical scanner that optically reads symbols using infrared light, for example. In the case of the optical scanner, in the case of the first state in which the optical scanner is mounted on the holding table 4, the operator takes out one piece of the item M placed in the basket from the basket, brings the item M close to the optical scanner, and optically reads the symbol. When such an operation is performed, the distance or reading depth at which the optical scanner can read the symbol may not be too far. Further, in the case of the second state in which the optical scanner is removed from the holding table 4, the operator may read, for example, a symbol attached to an item M (for example, a large and heavy item such as rice or packed drinking water) loaded on the lower stage of the shopping cart with a certain distance apart (for example, through a counter). When such an operation is performed, the distance or reading depth at which the optical scanner can read the symbol (or a scan range) needs to be farther or greater than in the first state. Therefore, when the optical scanner is in the first state, the intensity of light emitted from the vicinity of the optical scanner or the optical scanner is reduced, and when the optical scanner is in the second state, the intensity of light emitted from the vicinity of the optical scanner or the optical scanner is made larger than that of the first state.

The program executed by the wireless tag reading device 1 according to the above-described embodiments and the modification may be recorded in a computer-readable recording medium such as a CD-ROM, a flexible disk (FD), or a CD-R, DVD (Digital Versatile Disk) in an installable format or an executable format.

Further, the program executed by the wireless tag reading device 1 according to the above-described embodiments and the modification may be stored in a computer connected to a network such as the Internet, and may be downloaded via the network. Further, the program executed by the wireless tag reading device 1 according to the above-described embodiments and the modification may be provided or distributed via a network such as the Internet.

Further, the program executed by the wireless tag reading device 1 of the above-described embodiments and the modification may be installed in the ROM 37 or 72 or the storage device 31 or 74 in advance.

What is claimed is:

1. A reading device for reading item information about an item to be registered for purchase by a point-of-sale (POS) terminal, the reading device comprising:
a main body from which a reading signal is output;
a grip connected to the main body and including a sensor at a bottom portion of the grip, the bottom portion being attachable to a holding structure; and
a controller configured to:
based on a signal from the sensor, determine whether the reading device is in a first state in which the reading device is attached to the holding structure or in a second state in which the reading device is detached from the holding structure,
determine an intensity of the reading signal to be output based on whether the reading device is in the first state or the second state,
cause the reading signal to be output with the determined intensity and acquire item information from a response signal, and
transmit the acquired item information to the POS terminal for registration.

2. The reading device according to claim 1, wherein
the reading signal is a radio signal, and
the main body includes an antenna from which the radio signal is output and by which the response signal is received.

3. The reading device according to claim 2, wherein
the intensity of the reading signal to be output corresponds to an output power of the radio signal, and
the controller is configured to determine to use a first output power when the reading device is in the first state and a second output power that is less than the first output power when the reading device is in the second state.

4. The reading device according to claim 2, wherein
the intensity of the reading signal corresponds to a bandwidth of the radio signal, and
the controller is configured to determine to use a first bandwidth when the reading device is in the first state and a second bandwidth that is less than the first bandwidth when the reading device is in the second state.

5. The reading device according to claim 1, wherein
the reading signal is infrared light.

6. The reading device according to claim 5, wherein
the intensity of the reading signal corresponds to a scan range of the infrared light, and
the controller is configured to determine to use a first scan range when the reading device is in the first state and a second scan range that is greater than the first scan range when the reading device is in the second state.

7. The reading device according to claim 1, further comprising:
a switch on a surface of the grip, wherein
the controller causes the reading signal to be output when the reading device is in the second state and the switch is on.

8. The reading device according to claim 7, wherein
the controller causes the reading signal to be output regardless of a state of the switch when the reading device is in the first state.

9. The reading device according to claim 7, wherein
the main body includes a window through which the reading signal is output and the window and a surface of the switch face a same direction.

10. The reading device according to claim 1, wherein
the sensor is a magnetic sensor configured to detect a magnet attached to or embedded in the holding structure.

11. A method performed by a reading device for reading item information about an item to be registered for purchase by a point-of-sale (POS) terminal, the reading device including:
a main body from which a reading signal is output, and
a grip connected to the main body and including a sensor at a bottom portion of the grip, the bottom portion being attachable to a holding structure, the method comprising:
based on a signal from the sensor, determining whether the reading device is in a first state in which the reading device is attached to the holding structure or in a second state in which the reading device is detached from the holding structure;
determining an intensity of the reading signal to be output based on whether the reading device is in the first state or the second state;
outputting the reading signal with the determined intensity, and acquiring item information from a response signal; and
transmitting the acquired item information to the POS terminal for registration.

12. The method according to claim 11, wherein
the reading signal is a radio signal, and
the main body includes an antenna from which the radio signal is output and by which the response signal is received.

13. The method according to claim 12, wherein
the intensity of the reading signal to be output corresponds to an output power of the radio signal, and
the method further comprises:
determining to use a first output power when the reading device is in the first state and a second output power that is less than the first output power when the reading device is in the second state.

14. The method according to claim 12, wherein
the intensity of the reading signal corresponds to a bandwidth of the radio signal, and
the method further comprises:
determining to use a first bandwidth when the reading device is in the first state and a second bandwidth that is less than the first bandwidth when the reading device is in the second state.

15. The method according to claim 11, wherein
the reading signal is infrared light.

16. The method according to claim 15, wherein
the intensity of the reading signal corresponds to a scan range of the infrared light, and
the method further comprises:
determining to use a first scan range when the reading device is in the first state and a second scan range that is greater than the first scan range when the reading device is in the second state.

17. The method according to claim 11, wherein
the reading device includes a switch on a surface of the grip, and
the reading signal is output when the reading device is in the second state and the switch is on.

18. The method according to claim 17, wherein
the reading signal is output regardless of a state of the switch when the reading device is in the first state.

19. A system for reading item information about an item to be registered for purchase by a point-of-sale (POS) terminal, the system comprising:
a reading device that includes:
a main body from which a reading signal is output, and
a grip connected to the main body; and
a holding structure to which the reading device is attachable and including a sensor configured to output a signal indicating whether the grip is on a surface of the holding structure, wherein
the reading device further includes a controller configured to:
determine an intensity of the reading signal to be output based on the signal from the sensor,
cause the reading signal to be output with the determined intensity and acquire item information from a response signal, and
transmit the acquired item information to the POS terminal for registration.

20. The system according to claim 19, wherein
the holding structure includes a pair of columns between which the reading device is attachable,
the sensor includes a light emitter disposed in one of the columns and a light receiver disposed in the other column and facing the light emitter, and
the light receiver is configured to output the signal indicating whether light emitted from the light emitter is received.
